(19) United States
(12) Patent Application Publication
(10) Pub. No.: US 2017/0213477 A1
(43) Pub. Date: Jul. 27, 2017

(54) TRAINING ASSEMBLY FOR TWO-WHEEL VEHICLE WITH INDEPENDENTLY MOVABLE FOOT PLACEMENT SECTIONS

(71) Applicant: Hoverbars, LLC, Columbia, SC (US)

(72) Inventors: Robert W. Honeycutt, Pawleys Island, SC (US); Jason Charles Rosenburg, Pawleys Island, SC (US); Gregory S. Clemson, Florence, SC (US); Jeff W. Reichert, Pawleys Island, SC (US)

(21) Appl. No.: 15/415,454

(22) Filed: Jan. 25, 2017

Related U.S. Application Data
(60) Provisional application No. 62/286,660, filed on Jan. 25, 2016.

(51) Int. Cl. G09B 19/16; B62H 7/00; G09B 19/00

(52) U.S. Cl. CPC G09B 19/167; G09B 19/003; B62H 7/00

(57) ABSTRACT

A removable training assembly for use with a two-wheel standing vehicle having two platforms pivotal with respect to each other. The assembly comprises forward and rearward wheel sets fixed with respect to a connecting structure. The connecting structure is removably attachable to the vehicle such that the platforms of the two-wheel standing vehicle may pivot.

### PRIORITY CLAIM

This application claims the benefit of U.S. provisional application Ser. No. 62/286,660, filed Jan. 25, 2016, incorporated herein by reference in its entirety.

### BACKGROUND OF THE INVENTION

The present invention relates to two-wheel, self-balancing vehicles typically referred to as “hoverboards.” More particularly, the present invention relates to a removable training assembly for a user learning to operate a hoverboard.

A two-wheel self-balancing vehicle with which embodiments of the present invention may be used is shown and described in U.S. Pat. No. 8,738,278 to Chen, incorporated fully herein by reference for all purposes. The vehicle has first and second platform structures with respective foot placement sections or areas. A respective wheel is mounted outboard of each of the two platforms. The housing of each platform contains a motorized hub for driving the respective wheel.

The platform structures are movably coupled to each other such that they pivot about an interconnecting shaft. The rider, standing with feet on respective platforms, operates and steers the vehicle by relative tilting of the two platforms with respect to each other. If the rider falls off the vehicle, the absence of weight on the platforms is detected and the vehicle stops.

While an experienced rider can operate the vehicle with ease, the process of learning to ride such a vehicle is difficult. Novice riders may fall off the vehicle frequently, which at the least can be an unpleasant experience.

The present invention recognizes the foregoing considerations, and others, of the prior art.

### SUMMARY OF THE INVENTION

In accordance with one aspect, the present invention provides a removable training assembly for use with a two-wheel standing vehicle having two platforms pivotal with respect to each other. The assembly comprises forward and rearward wheel sets fixed with respect to a connecting structure. The connecting structure is removably attachable to the vehicle such that the platforms of the two-wheel standing vehicle may pivot.

According to some exemplary embodiments, each of the wheel sets includes first and second wheel assemblies associated with respective platforms of the vehicle. For example, the first and second wheel assemblies may comprises an arm extending away from the connecting structure carrying at least one wheel at a distal end thereof. In some cases, each of the wheels rotates about an axis parallel to wheels of the two-wheel standing vehicle. The arms may extend from the connecting structure such that the wheels of both the forward and rearward wheel sets will be off the ground when the platforms of the two-wheel standing vehicle are level.

Many preferred embodiments may include a handlebar arrangement that a rider can hold during the training process. The handlebar arrangement may comprise first and second handle arms each having a handle portion at a distal end thereof. Preferably, the first and second handle arms are removably attachable to at least one of the connecting structure and the first and second wheel assemblies of the forward wheel set.

In some embodiments, the connecting structure may comprises separate first and second connecting arrangements attachable to respective of the two platforms of the two-wheel standing vehicle. For example, each of the connecting arrangements may comprise a base portion that extends under the respective of the two platforms of the two-wheel standing vehicle. The base portion in such embodiments may have an arcuate configuration defining a receiving area for complementary receipt of a respective of the two platforms of the two-wheel standing vehicle. Moreover, the base portion may be secured to the respective of the two platforms of the two-wheel standing vehicle via at least one pivotal linkage, such as forward and rearward pivotal linkages. Alternatively, the base portion may secured to the respective of the two platforms of the two-wheel standing vehicle via a slidable clamp.

Other embodiments are contemplated in which the connecting structure comprises a single connecting structure to which forward and rearward wheel assemblies are connected, the wheel assemblies carrying the respective forward and rearward wheel sets. For example, the connecting structure may be mounted about the mid-portion of the vehicle where the platforms pivot with respect to each other.

A further aspect of the present invention comprises a removable training assembly for use with a two-wheel standing vehicle having two platforms pivotal with respect to each other. The assembly comprises forward and rearward wheel sets fixed with respect to a connecting structure, each of the wheel sets includes first and second wheel assemblies associated with respective platforms of the vehicle respectively having at least one wheel. According to this aspect, the wheels of both the forward and rearward wheel sets will be off the ground when the platforms of the two-wheel standing vehicle are level. The connecting structure includes separate first and second connecting arrangements attachable to respective of the two platforms of the two-wheel standing vehicle.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a perspective view showing a rider standing on a hoverboard vehicle equipped with a training assembly in accordance with an embodiment of the present invention.

FIGS. 2 and 3 are front perspective views of the hoverboard and training assembly shown in FIG. 1.

FIG. 4 is an enlarged perspective view of the hoverboard and training assembly shown in FIG. 1 showing additional detail.

FIG. 5 is a perspective view of a training assembly in accordance with an alternative embodiment of the present invention connected to a hoverboard vehicle.

FIG. 6 is a plan view of the training assembly of FIG. 5.

FIGS. 7 and 8 are enlarged views respectively showing the connecting linkage engaged and not engaged with the vehicle platform.

FIG. 9 is an enlarged fragmentary view showing a training assembly in accordance with an alternative embodiment of the present invention.

FIG. 10 shows top and bottom housing portions of the connecting structure housing of the embodiment of FIG. 9 separated so that internal components can be seen.

FIG. 11 shows the manner in which the top and bottom housing portions are connected to each other and to the wheel assemblies.

FIG. 12 is a side elevational view of a training assembly in accordance with an alternative embodiment of the present invention connected to a hoverboard vehicle.

FIG. 13 is a perspective view of the hoverboard and training assembly of FIG. 12.

FIG. 14 is an enlarged fragmentary perspective view from below of the hoverboard and training assembly of FIG. 12.

FIG. 15 is an enlarged elevational view of the base portion of a connecting arrangement of the training assembly of FIG. 12.

FIGS. 16 and 17 are front and rear perspective views of the base portion of

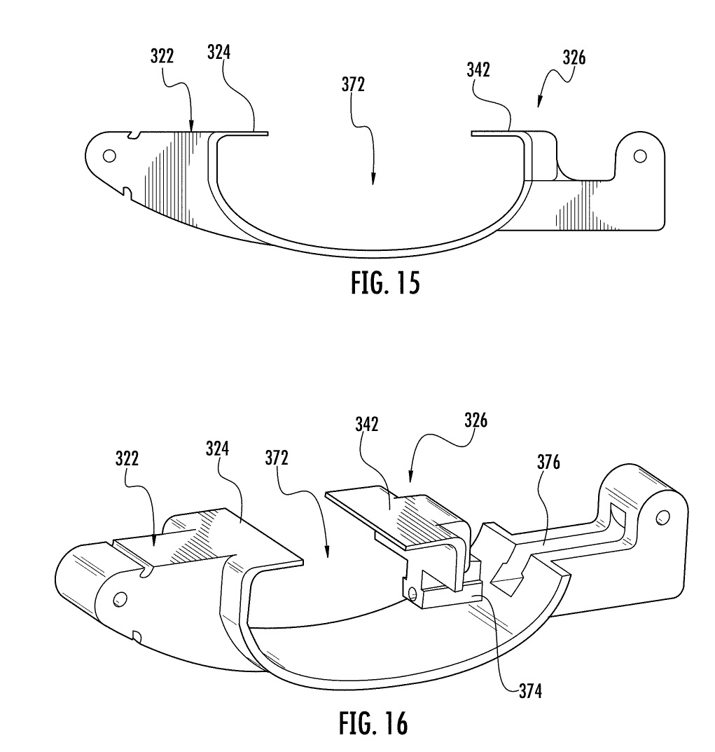

FIG. 15 with the clamp separated to show the manner in which it moves axially along a track.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

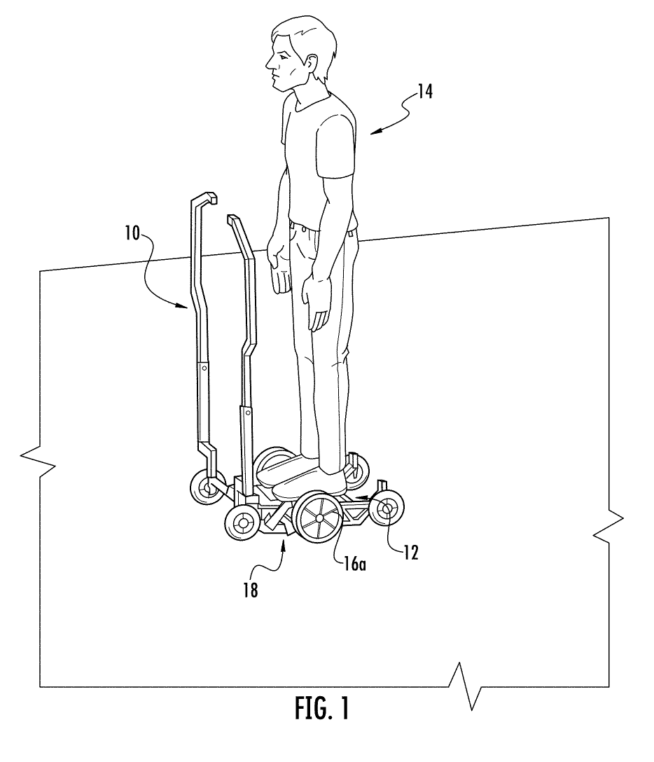

FIGS. 1-4 illustrate a training assembly 10 in accordance with an embodiment of the present invention being used with a hoverboard vehicle 12. A rider 14 stands on the vehicle 12 and uses training assembly 10 to learn how to ride and operate vehicle 12. Vehicle 12 has a pair of independently movable platforms for the rider's feet. Outboard of the platforms are the vehicle's two wheels 16a and 16b.

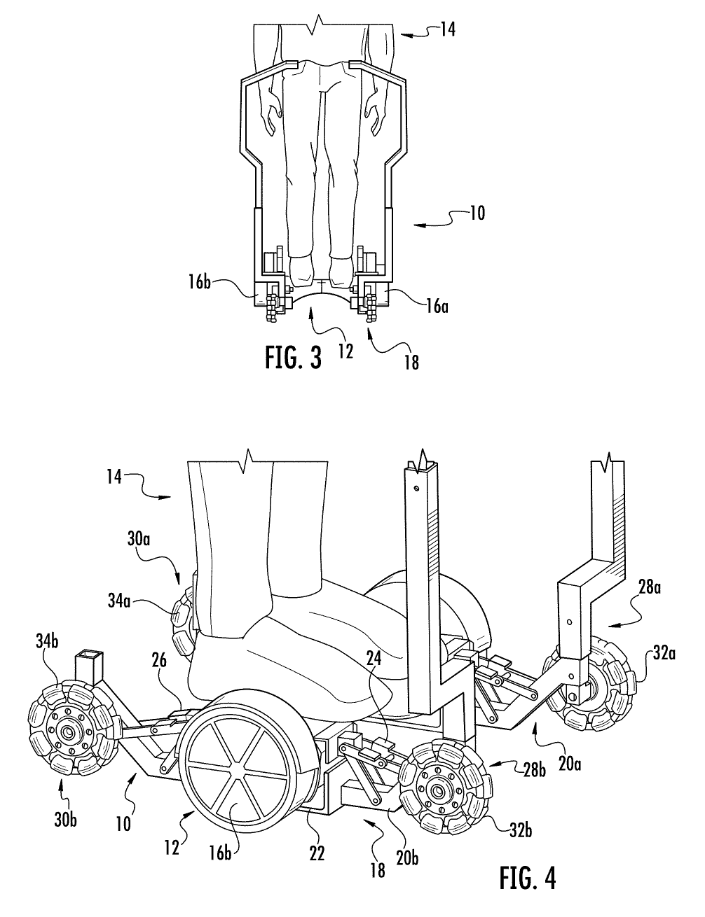

Referring now particularly to FIG. 4, training assembly 10 includes a connecting structure 18 removably attachable to vehicle 12. In this embodiment, connecting structure 18 comprises first and second connecting arrangements 20a and 20b attachable to the respective platforms. Connecting arrangements 20a and 20b each have a base portion of “plate” (e.g., base plate 22) that extends below the respective platform in a manner that does not interfere with the pivotal operation of the platform. For example, the base portion may be secured to the platform but does not contact the ground (i.e., the rolling surface) as the platform is pivoted by a user. Each of the connecting arrangements 20a and 20b further includes a forward linkage 24 and a rearward linkage 26. Linkages 24 and 26, described more fully below, provide removable attachment to the respective platform.

Forward and rearward wheel assemblies 28a-b and 30a-b integrally extend from the respective connecting arrangements 20a-b. In this case, wheel assemblies 28a-b include a corresponding forward wheel 32a-b, whereas wheel assemblies 30a-b include a corresponding rearward wheel 34a-b. The wheels 32a-b and 34a-b are in a fixed orientation in this embodiment such that they only rotate about an axis parallel to the rotational axis of wheels 16a-b. In other embodiments, one or more wheels of training assembly 10 can be turned so as to provide a greater range of movement.

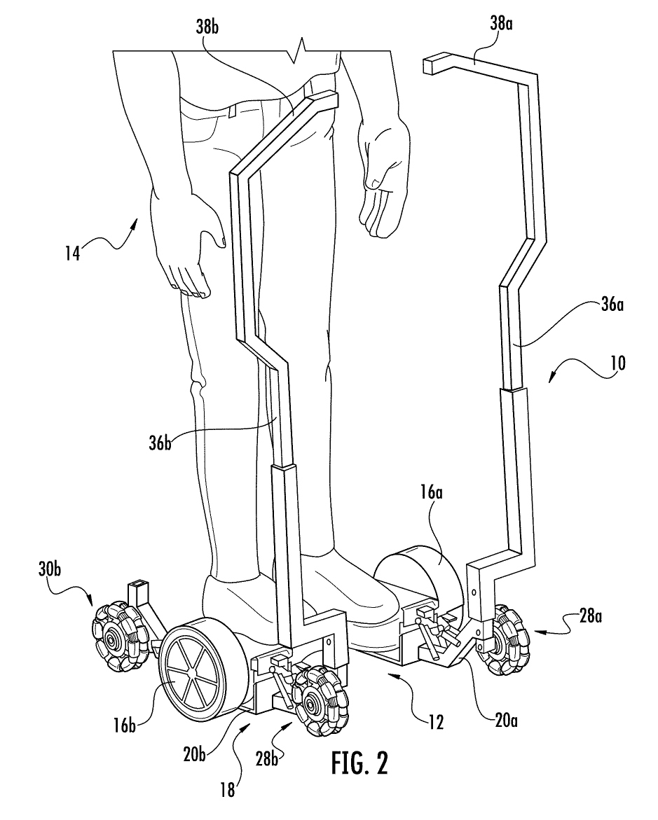

As can be seen most clearly in FIG. 2, a handlebar arrangement may be provided to facilitate ease of use. In this embodiment, for example, the handlebar arrangement comprises first and second handle arms 36a-b that extend upwardly from a respective forward wheel assembly 28a-b. Arms 36a-b carry a respective handle 38a-b at their distal ends. The height of handles 38a-b is preferably chosen to be comfortable for gripping by the rider. Embodiments are contemplated in which the handles are stationary and merely provide additional balance to the rider. In other embodiments, the handles may be movable to facilitate turning of vehicle 12 during the training process. Preferably, the handlebar arrangement may be removable to facilitate training of riders farther along in the training process.

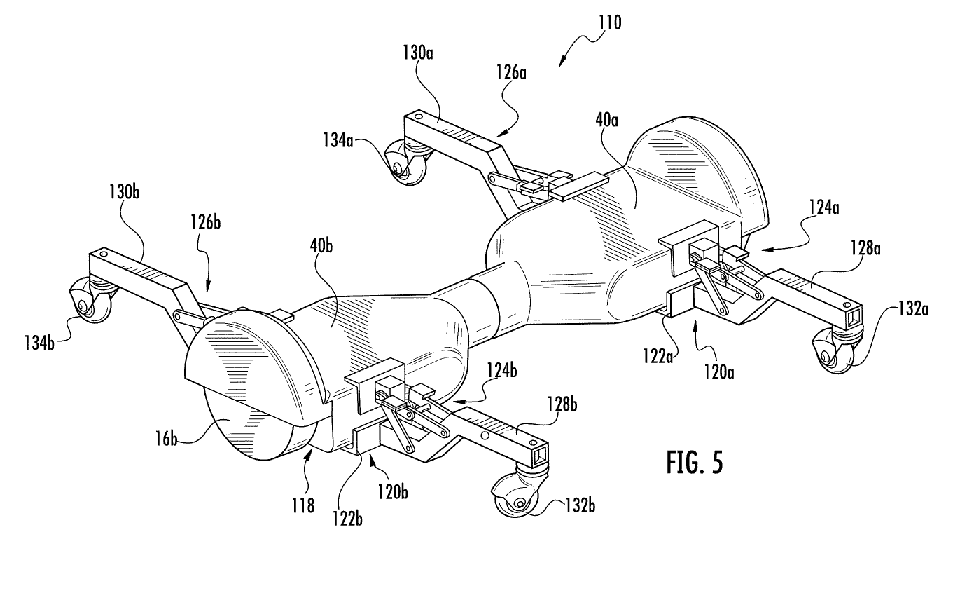

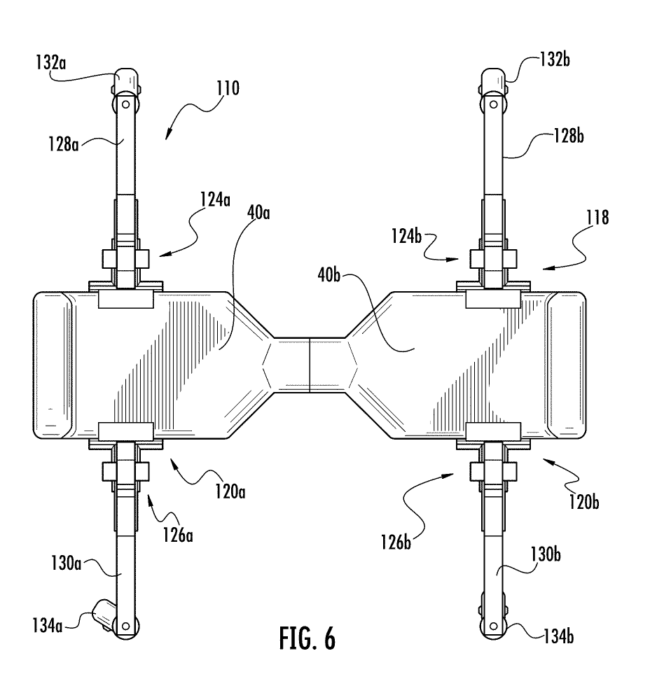

FIGS. 5-8 illustrate a training assembly 110 in accordance with an alternative embodiment of the present invention. In many respects, training assembly 110 is similar to training assembly 10, although this embodiment, as illustrated, does not include handle arms. One skilled in the art will appreciate, however, that handle arms (either permanent or removable) could be provided. Another difference is that wheels 132a-b and 134a-b are configured as casters in this embodiment. As is well known, casters swivel about a vertical pivot so that their rolling direction can be easily changed. While casters are shown, one skilled in the art will appreciate that these wheels may also be configured as in-line bidirectional wheels like those shown in FIGS. 1-4, or in-line wheels like those used on skateboards and in-line skates.

The wheels are mounted at the ends of respective forward and rearward wheel assemblies 128a-b and 130a-b configured as arms to carry the associated wheels. The wheel assemblies extend from a connecting structure 118 comprising, in this case, a pair of connecting arrangements 120a-b. Connecting arrangement 120a comprises a base plate 122a that extends under platform 40a of vehicle 12 so as not to interfere with its pivotal operation. For example, base plate 122a does not interfere with rotational movement of platform 40a relative to platform 40b. Similarly, connecting arrangement 120b includes a base plate 122b that extends under platform 40b. Linkages 124a-b and 126a-b provide attachment to the platforms 40a-b.

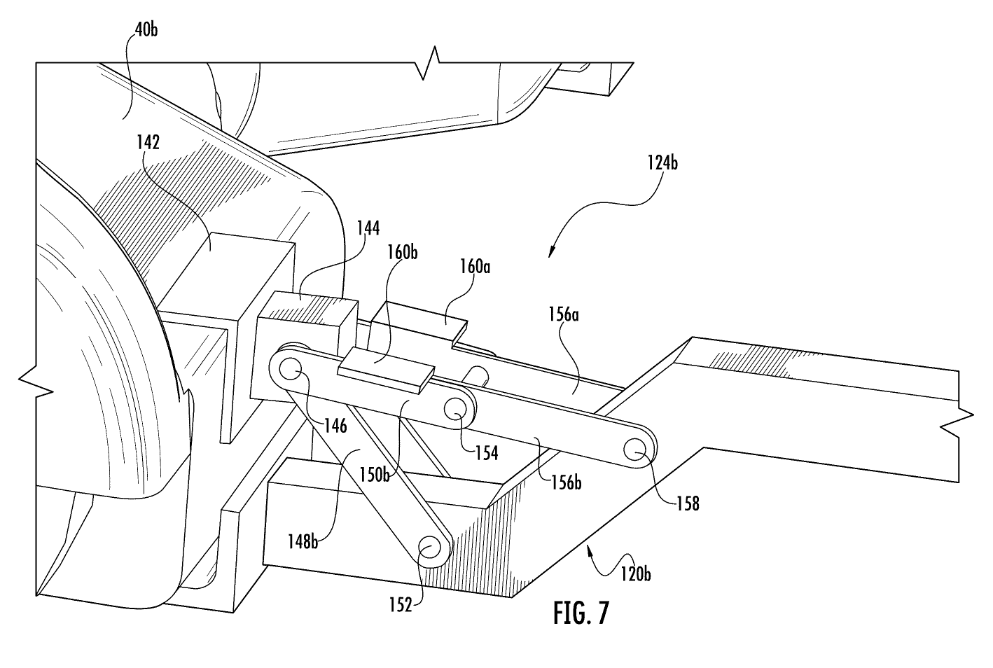

Referring FIGS. 7 and 8, linkage 124b is respectively shown in engaged and released positions relative to platform 40b. As shown, linkage 124b includes an L-shaped foot 142 adapted to contact platform 40b. In particular, the L-shaped structure of foot 142 causes it to engage both the forward edge and the top surface of platform 40b. It may be desirable to provide a softer elastomeric material, such as rubber, on the engaging faces of foot 142 so as to inhibit scratching of the platform.

A pivot block 144 is fixed to the backside of foot 142, as shown. Block 144 carries a pin 146 or other suitable structure about which the distal ends of bars 148a-b and 150a-b can rotate. Similarly, the proximal ends of bars 148a-b rotate with respect to connecting arrangement 120b at pivot 152. The distal ends of bars 150a-b are connected at an intermediate pivot 154 with bars 156a-b. The proximal ends of bars 156a-b rotate with respect to connecting arrangement 120b at pivot 158. As shown in FIG. 7, the distal ends of bars 156a-b carry lateral flanges 160a-b that serve as stops to align bars 150a-b with bars 156a-b in the engaged position. Flanges 160a-b also provide gripping tabs to facilitate engagement and disengagement of the linkage.

Thus, linkage 124b is connected to platform 40b by pushing down on flanges 160a-b until bars 150a-b and bars 156a-b are aligned. In this position, foot 142 will be engaged with platform 40b. A torsion spring may be located around pivot 154 to urge foot 142 into the engaged position. The spring will thus tend to prevent disengagement during use. In some cases, linkage 124b may rotate with respect to pivots 152 and 158 as the rider moves the platform. Or, as one skilled in the art will appreciate, the linkages may maintain the connecting arrangement snug with respect to the corresponding platform. In this event, one of the forward or rearward wheels, or both, will be off the ground depending on how the user pivots the platforms with respect to each other.

The other linkages have a similar structure and operation in this embodiment, so they need not be described in detail. Therefore, once all four linkages are connected to vehicle 12 in the described manner, training assembly 10 is ready to use.

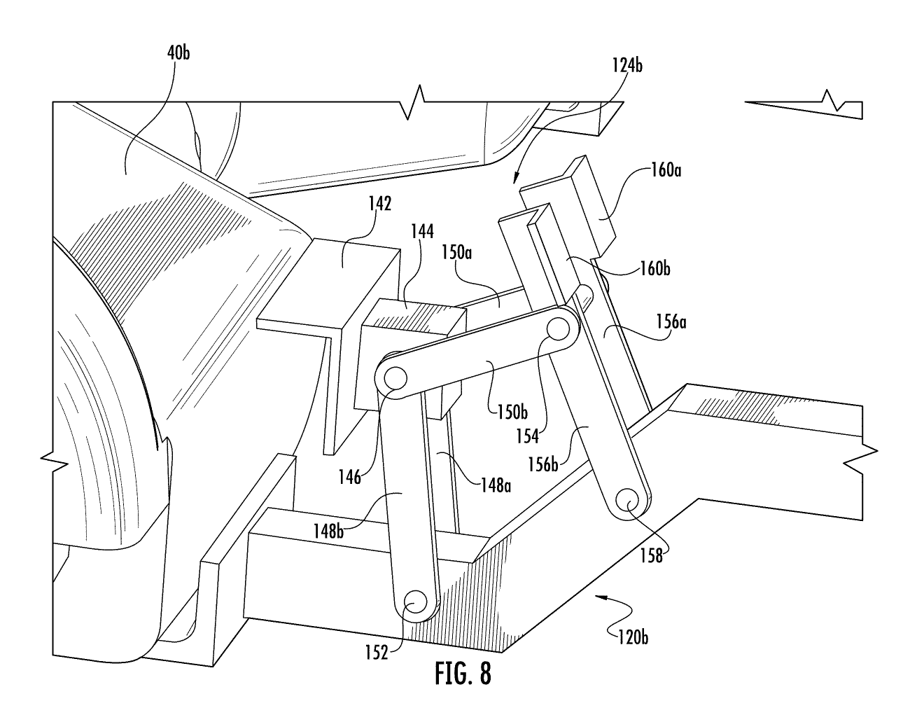

A training assembly 210 in accordance with an alternative embodiment of the present invention is shown in FIGS. 9-11. Referring first to FIG. 9, the connecting structure 218 comprises in this case a pair of connecting arrangements 220a-b in form of respective housings 262a-b. The forward and rearward wheel assemblies 228a-b and 230a-b are fixed with respect to and extend from housings 262a-b. Unlike the previous embodiments, housings 262a-b are located around the midportion of vehicle 10 where the platforms rotate with respect to each other.

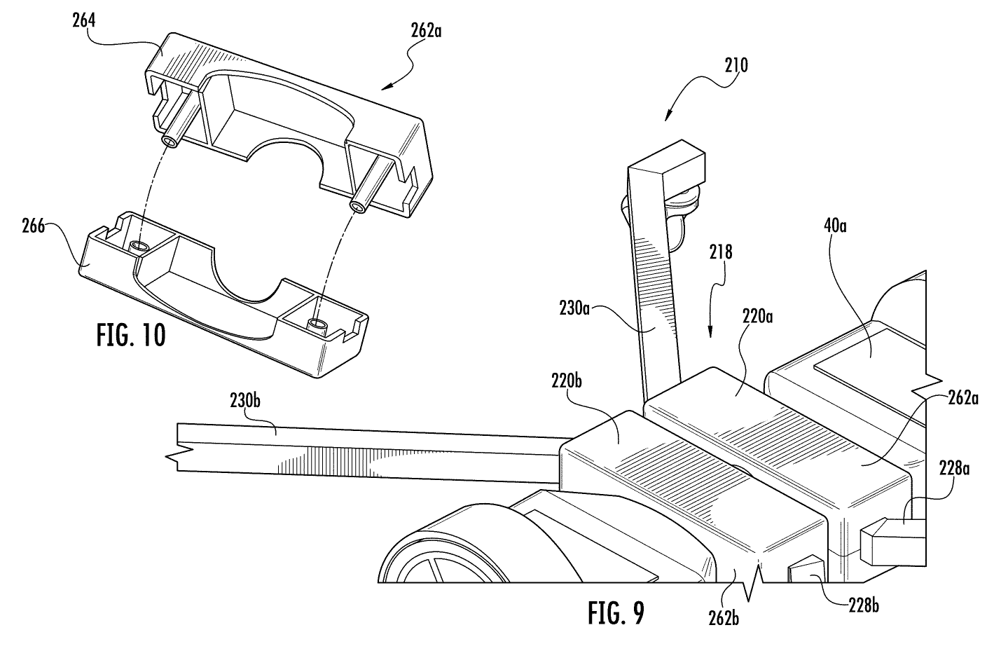

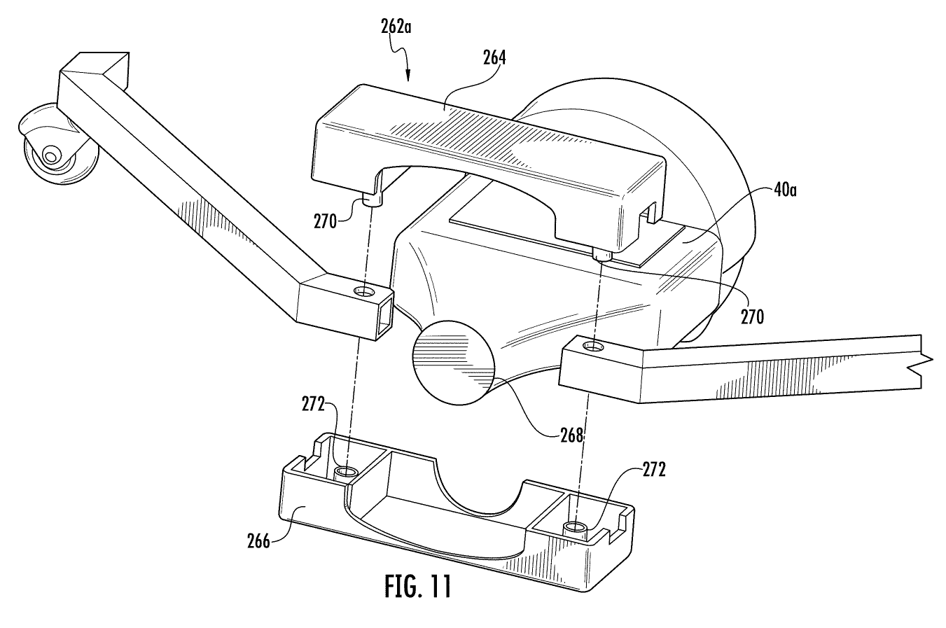

Referring now to FIGS. 10 and 11, certain additional details about the connecting arrangement housing can be seen. In particular, housing 262a is shown in this case, although it will be understood that housing 262b will be the mirror image. In fact, housing 262a is turned around in these drawings so that the outboard side is facing the viewer. The outboard side would actually be facing the adjacent wheel of vehicle 12 in use.

As can be seen, housing 262a has a top housing portion 264 and a bottom housing portion 266 that are joined together from above and below the vehicle platform. The outboard sides of the top and bottom housing portions together define a generally elliptical opening through which a widened portion of the platform passes. The inboard sides of the top and bottom housing portions together define a circular opening that is received around the circular portion 268 of vehicle 12 adjacent to where the platforms 40a and 40b rotate with respect to each other. Preferably, the circular opening will be snug enough around portion 268 to prevent excessive looseness.

In this case, top housing portion 264 contains a pair of depending dowels 270 that are received in corresponding bosses in bottom housing portion 266. Dowels 270 pass through holes defined in the proximal ends of the wheel support arms in order to fix them in position. In this embodiment, the arms are rectangular in cross section, and are received in apertures of the same shape defined in the forward and rearward sides of the connecting arrangement housing. Suitable fasteners may be provided to lock top housing portion 264 and bottom housing portion 266 in position with respect to one another. One skilled in the art will appreciate that the wheel support arms may be inclined slightly upward so that one of the wheels will engage the ground when the corresponding platform is tilted forward or back, but both wheels may be slightly above the ground when the platform is level.

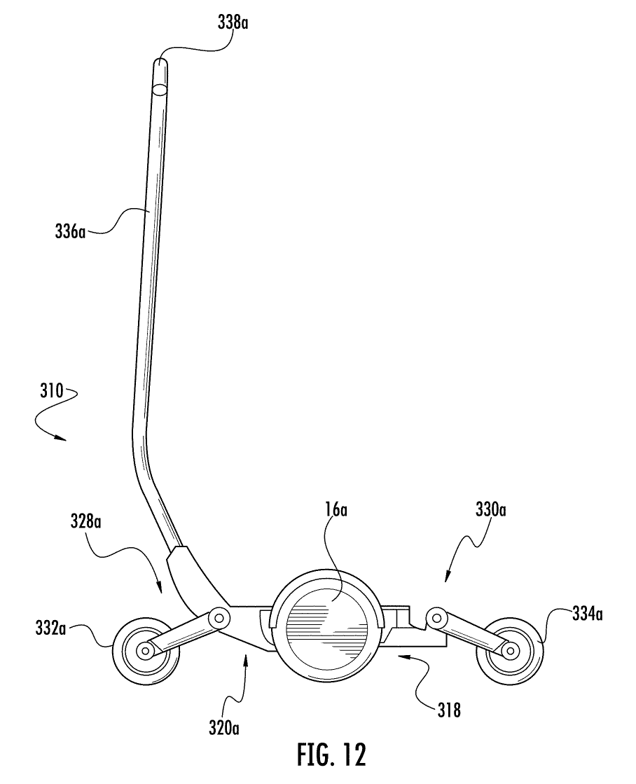

FIGS. 12-14 illustrate a training assembly 310 in accordance with an alternative embodiment of the present invention. Assembly 310 includes respective forward and rearward wheel assemblies 328a-b and 330a-b carrying the associated wheels 332a-b and 334a-b. One skilled in the art will appreciate that any of the wheel types discussed above can also be used in this embodiment. In FIGS. 12-14, however, the wheels 332a-b and 334a-b are in a fixed orientation such that they only rotate about an axis parallel to the rotational axis of wheels 16a-b.

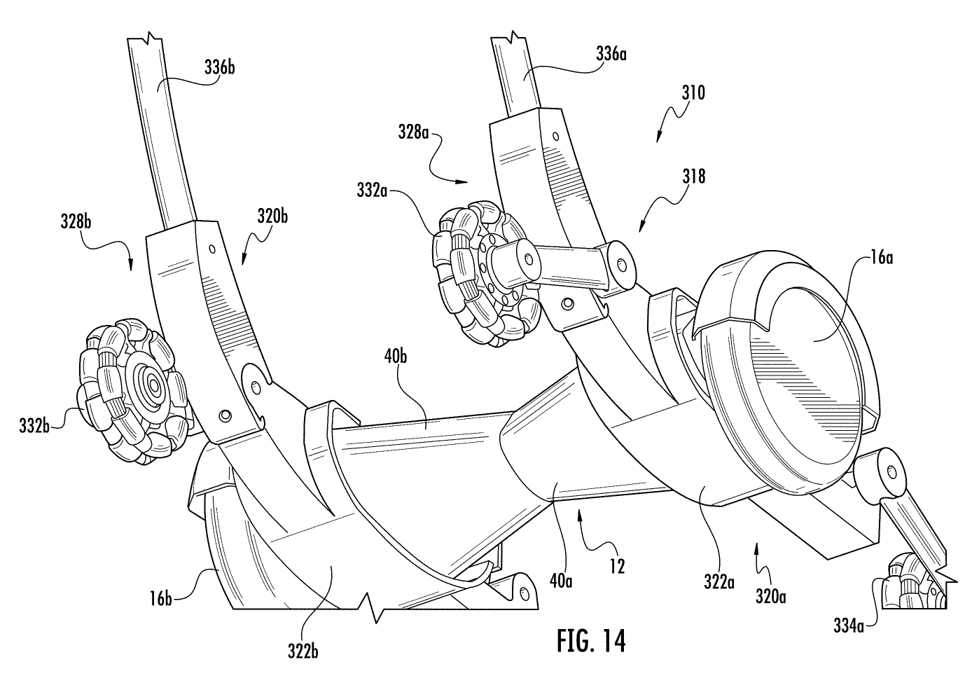

The wheel assemblies extend from a connecting structure 318 comprising, in this case, a pair of separate connecting arrangements 320a-b. As most easily seen in FIG. 14, connecting arrangement 320a comprises a base portion 322a that extends under platform 40a of vehicle 12 so as not to interfere with its pivotal movement. Similarly, connecting arrangement 320b includes a base portion 322b that extends under platform 40b. Clamps provide attachment to the platforms 40a-b as described more fully below.

Preferably, the wheel assemblies are pivotable and adjustable when connected to the connecting structure 318. This adjustment allows for varying degrees of wheel elevation, to facilitate training on the vehicle 12 (such as training wheels on a bicycle may be adjusted up or down depending on the rider's confidence).

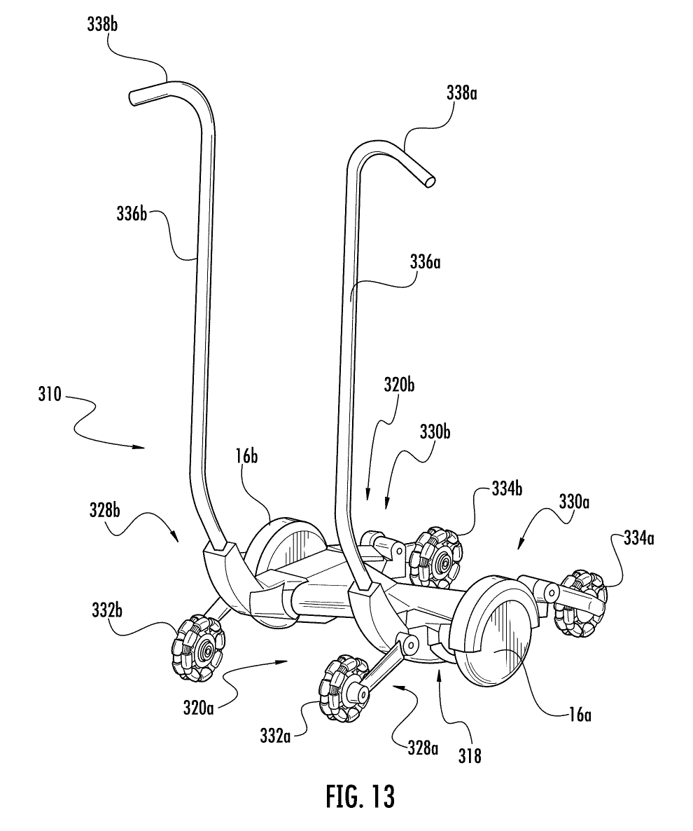

Referring again to FIGS. 12 and 13, a handlebar arrangement is provided in this embodiment. The handlebar arrangement includes first and second handle arms 336a-b that extend upwardly from a respective forward wheel assembly 328a-b. Arms 336a-b carry a respective handle 338a-b at their distal ends. The handlebar arrangement may be removable to facilitate training of riders farther along in the training process. Or, alternatively, the wheel assemblies may be detachable from the respective connecting arrangements so as to leave the handlebar arrangement in place. Even skilled users of vehicle 12 may prefer to sometimes ride with handles in place.

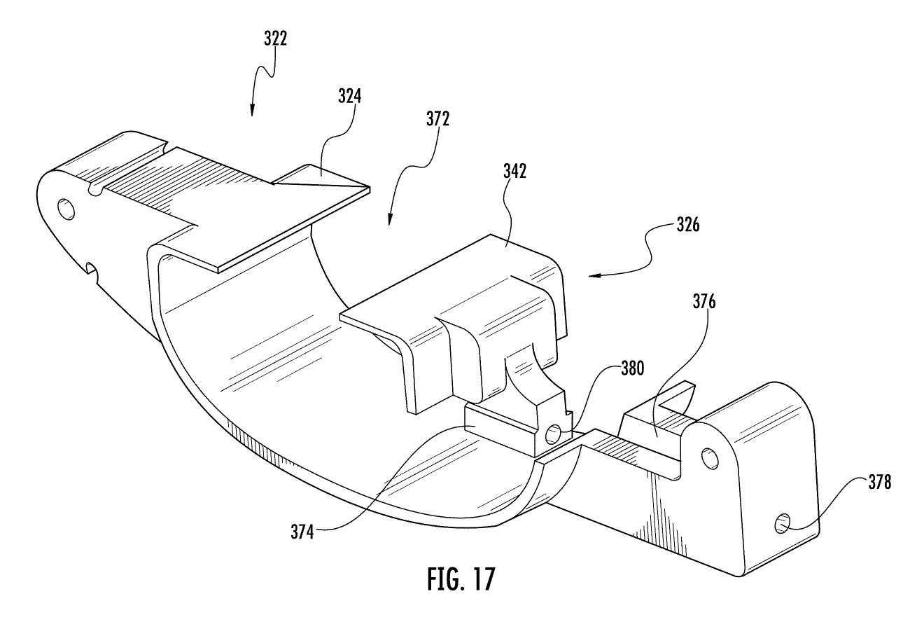

The manner in which the respective base portions are attached to the platforms of the vehicle can be most easily described with reference to FIGS. 15-17. As shown, a base portion 322 has as an arcuate shape defining a receiving area 372 for complementary receipt of a respective platform of the vehicle. In this case, the forward edge of the platform is received under a catch or “lip” 324 integrally formed as part of base portion 322. The base portion, and thus the connecting arrangement, is secured using a clamp 326 that engages the rearward edge of the platform. In this embodiment, clamp 326 includes an L-shaped foot 342 (which may be a mirror image of catch 324) adapted to contact the platform. As described above in relation to previous embodiments, it may be desirable to provide a softer elastomeric material, such as rubber, on the engaging faces of foot 342 so as to inhibit scratching of the platform.

In this embodiment, clamp 326 is adapted to move axially toward and away from the platform in order to provide a secure connection. In this regard, clamp 326 may include an integral key structure 374 as shown. Key structure 374 is slidably received in a complementary track 376 defined in base portion 322. Various mechanisms are contemplated to advance and retract clamp 326. In the illustrated embodiment, for example, a threaded adjustment bolt may extend through an aperture 378 (FIG. 17) defined in base portion 322 through an aligned bore 380 in clamp 326. Although clamp 326 is located on the rearward side of the platform in this embodiment, one skilled in the art will appreciate that the sides could be reversed (i.e., clamp 326 could be on the forward side with lip 324 on the rearward side).

It can thus be seen that the present invention provides a novel training assembly for a user learning to operate a hoverboard. One skilled in the art would be able to determine the most appropriate materials from which to form the various components described above in order to meet anticipated strength and rigidity requirements. In many cases, however, the various structural components may be formed of steel or another suitable metal.

While preferred embodiments of the invention have been shown and described, modifications and variations may be made thereto by those of ordinary skill in the art without departing from the spirit and scope of the present invention. In addition, it should be understood that aspects of the various embodiments may be interchanged both in whole or in part to yield still further embodiments. Furthermore, those of ordinary skill in the art will appreciate that the foregoing description is by way of example only, and is not intended to be limitative of the invention as further described in the appended claims.

What is claimed is:

1. A removable training assembly for use with a two-wheel standing vehicle having two platforms pivotal with respect to each other, said assembly comprising:
forward and rearward wheel sets fixed with respect to a connecting structure; and
said connecting structure being removably attachable to the vehicle such that the platforms of the two-wheel standing vehicle may pivot.

2. The removable training assembly of claim 1, wherein each of the wheel sets includes first and second wheel assemblies associated with respective platforms of the vehicle.

3. The removable training assembly of claim 2, wherein each of said first and second wheel assemblies comprises an arm extending away from the connecting structure carrying at least one wheel at a distal end thereof.

4. The removable training assembly of claim 3, wherein said at least one wheel of said first and second wheel assemblies rotates about an axis parallel to wheels of the two-wheel standing vehicle.

5. The removable training assembly of claim 2, wherein the arms extend from the connecting structure such that the wheels of both said forward and rearward wheel sets will be off the ground when the platforms of the two-wheel standing vehicle are level.

6. The removable training assembly of claim 2, further comprising a handlebar arrangement that a rider can hold during the training process.

7. The removable training assembly of claim 6, wherein the handlebar arrangement comprises first and second handle arms each having a handle portion at a distal end thereof.

8. The removable training assembly of claim 7, wherein the first and second handle arms are removably attachable to at least one of said connecting structure and said first and second wheel assemblies of the forward wheel set.

9. The removable training assembly of claim 1, further comprising a handlebar arrangement that a rider can hold during the training process.

10. The removable training assembly of claim 1, wherein the connecting structure comprises separate first and second connecting arrangements attachable to respective of the two platforms of the two-wheel standing vehicle.

11. The removable training assembly of claim 10, wherein each of said connecting arrangements comprises a base portion that extends under the respective of the two platforms of the two-wheel standing vehicle.

12. The removable training assembly of claim 11, wherein the base portion has an arcuate configuration defining a receiving area for complementary receipt of a respective of the two platforms of the two-wheel standing vehicle.

13. The removable training assembly of claim 10, wherein the base portion is secured to the respective of the two platforms of the two-wheel standing vehicle via at least one pivotal linkage.

14. The removable training assembly of claim 13, wherein said at least one pivotal linkage comprises forward and rearward pivotal linkages.

15. The removable training assembly of claim 10, wherein the base portion is secured to the respective of the two platforms of the two-wheel standing vehicle via a slidable clamp.

16. The removable training assembly of claim 1, wherein the connecting structure comprises a single connecting structure to which forward and rearward wheel assemblies are connected, the wheel assemblies carrying the respective forward and rearward wheel sets.

17. The removable training assembly of claim 16, wherein the connecting structure is mounted about the mid-portion of the vehicle where the platforms pivot with respect to each other.

18. A removable training assembly for use with a two-wheel standing vehicle having two platforms pivotal with respect to each other, said assembly comprising:
forward and rearward wheel sets fixed with respect to a connecting structure, each of the wheel sets including first and second wheel assemblies associated with respective platforms of the vehicle respectively having at least one wheel;
wherein the wheels of both the forward and rearward wheel sets will be off the ground when the platforms of the two-wheel standing vehicle are level; and
said connecting structure including separate first and second connecting arrangements attachable to respective of the two platforms of the two-wheel standing vehicle.

19. The removable training assembly of claim 18, wherein each of said first and second wheel assemblies comprises an arm extending away from the connecting structure carrying said at least one wheel at a distal end thereof.

20. The removable training assembly of claim 19, wherein said at least one wheel of said first and second wheel assemblies rotates about an axis parallel to wheels of the two-wheel standing vehicle.

21. The removable training assembly of claim 18, further comprising a handlebar arrangement that a rider can hold during the training process.

22. The removable training assembly of claim 18, wherein each of said connecting arrangements comprises a base portion that extends under the respective of the two platforms of the two-wheel standing vehicle.

23. The removable training assembly of claim 22, wherein the base portion has an arcuate configuration defining a receiving area for complementary receipt of a respective of the two platforms of the two-wheel standing vehicle.

24. The removable training assembly of claim 23, wherein the base portion is secured to the respective of the two platforms of the two-wheel standing vehicle via at least one pivotal linkage.

25. The removable training assembly of claim 23, wherein the base portion is secured to the respective of the two platforms of the two-wheel standing vehicle via a slidable clamp.
